(19) United States
(12) Patent Application Publication
(10) Pub. No.: US 2015/0040646 A1
(43) Pub. Date: Feb. 12, 2015

(54) METHOD FOR EVALUATING THE SEALING OF A BIPOLAR STRUCTURE FOR AN ELECTROCHEMICAL GENERATOR

(71) Applicants: Marianne Chami, Fontaine (FR); Sebastien Martinet, St Quentin / Isere (FR); Ludovic Rouillon, Villard de Lans (FR)

(72) Inventors: Marianne Chami, Fontaine (FR); Sebastien Martinet, St Quentin / Isere (FR); Ludovic Rouillon, Villard de Lans (FR)

(73) Assignee: COMMISSARIAT A L'ENERGIE ATOMIQUE ET AUX ENE ALT, Paris (FR)

(21) Appl. No.: 14/344,740

(22) PCT Filed: Sep. 13, 2012
(86) PCT No.: PCT/EP2012/068001

§ 371 Date: Mar. 13, 2014

(30) Foreign Application Priority Data
Sep. 15, 2011 (FR) 11 58214

(51) Int. Cl. H01M 10/42; G01M 3/26

(52) U.S. Cl. CPC H01M 10/4228; G01M 3/26
USPC 73/49.8

(57) ABSTRACT

A method for evaluating sealing of a bipolar structure including a sheet-like substrate forming a current collector, and two electrodes in a form of films arranged on opposite surfaces of the substrate, respectively, the method including: placing the bipolar structure in a cavity to define first and second compartments therein, which are separated by the bipolar structure, a periphery of which is sealingly connected to the cavity; circulating a fluid in the first compartment of the cavity toward the second compartment; and evaluating sealing of the bipolar structure from a measurement of difference in pressure of the fluid in the first and second compartments.

### TECHNICAL FIELD

The present invention relates to the field of electrochemical generators, preferably lithium batteries and accumulators, in which the stack comprises at least one bipolar structure, normally referred to as “bipolar electrode”.

This type of electrochemical generator operates on the principle of insertion or de-insertion (or intercalation/de-intercalation) of lithium on at least one electrode.

In fact, the electrochemical reaction behind the production of current brings into play the transfer of lithium cations, through a lithium ion conductor electrolyte, said cations coming from a negative electrode either inserting themselves into the acceptor network of the positive electrode, or resupplying the electrolyte with lithium ions.

These electrochemical generators find their application in numerous technical fields, particularly in the supply of embedded systems of low thickness, such as credit cards, intelligent labels, in the supply of mobile telephones, or instead in the supply of electric vehicles.

The invention also applies to the field of electrochemical super-capacitors in which at least one of the two electrodes operates by adsorption reactions.

### STATE OF THE PRIOR ART

With reference to FIGS. 1 and 2, a lithium electrochemical generator 1 is represented, formed of a stack of elements that will be described below.

The generator firstly comprises a positive electrode at the upper end of the stack, said electrode including an aluminium conductor substrate 2 and a positive active layer 4 based on Li_{1.04}Mn_{1.96}O₄, LiFePO₄, or any other lithium insertion material. In an analogous manner, a negative electrode is provided at the lower end of the stack, said electrode including a conductor substrate made of aluminium 6 and a negative active layer 8 based on Li₄Ti₅O₁₂.

These two end electrodes tightly hug one or more bipolar structures, also referred to as bipolar electrodes, each including a positive active layer 10 and a negative active layer 12 on either side of a common aluminium conductor substrate 14, made of a single piece or in the form of two superimposed substrates, as is described in the document WO 03/047021. More generally, each bipolar structure 16 comprises the sheet-like substrate 14 forming a current collector of the structure, as well as the two electrodes 10, 12 in the form of films arranged on the opposite surfaces of the substrate, respectively.

Each active layer is deposited on the aluminium metal sheet by spread coating on a metal substrate of an electrode ink comprising the active material, the electronic conductor and the polymer, usually vinylidene polyfluoride when the electrodes are produced by organic process. The polymer is dissolved in a solvent, which is generally N-methyl pyrollidone. After evaporation of the latter, the polymer, perfectly dispersed with the powders, enables the clinging of the grains of active materials and electronic conductor together and on the aluminium current collector.

In addition, the electrodes arranged at the ends of the stack are separated from the bipolar electrode by two microporous separators 18, 20, respectively in contact with the electrodes 12 and 10 of the bipolar structure.

Finally, the sealing of the assembly is assured by a gasket 22 generally based on polytetrafluoroethylene (PTFE), optionally constituted of several elements, and surrounding the periphery of the stack.

The accumulator shown in FIG. 1 thus has a plurality of electrochemical cells connected in series via the bipolar structure(s). This makes it possible to increase the average voltage of a monopolar Li-ion accumulator, while conserving a comparable energy density.

The architecture is thus qualified as bipolar, because it comprises a positive active layer of a cell and a negative active layer of an adjacent cell which are supported by a same current collector structure, itself qualified as bipolar electrode. The architecture of a bipolar accumulator thus corresponds to internally placing in series several monopolar accumulators through electrodes or bipolar current collectors, with particularly the advantage of having a reduced electrical resistance compared to conventional monopolar accumulators connected in series by external connectors. In this respect, this is known from numerous patents and patent applications relating to such bipolar batteries, such as US2005/0069768, U.S. Pat. No. 7,279,248, U.S. Pat. No. 7,220,516, U.S. Pat. No. 7,320,846, U.S. Pat. No. 7,163,765, WO 03/047021, WO 2006/061696, U.S. Pat. No. 7,097,937.

When the peripheral sealing of the electrochemical generator fails, major visual elements bear witness to the fact, such as a leak of the liquid electrolyte, a taking up of water of the electrolyte which is capable of leading to corrosion of the aluminium, beginning by its periphery. On the other hand, the sealing of bipolar structures is not detectable visually, and no technique is known to evaluate it.

This may prove to be problematic, given that a risk of ionic short-circuit via the current collector itself exists, which may in fact be perforated during the manufacture of bipolar structures, and in particular during the step of compression of the electrodes by calendering and/or pressing. Such a step is effectively implemented in order to attain the target porosities and thicknesses for electrodes in the form of layers adhering to the current collector. It is generally carried out by passing the bipolar structure between two compressor rollers causing the heating and calendering thereof.

In this respect, it is recalled that to optimise the operation of the bipolar structure, it is necessary to compress its two electrode forming layers on the substrate, such that they adopt an optimal porosity, the value of which depends on the intended applications for the accumulator (low for an accumulator with high energy density, optimised for a power accumulator). The porosity must be high enough to enable the wettability of the electrode by the electrolyte and optimise ionic diffusion during the cycling of the accumulator. It must also be reduced to the maximum to improve the contact of the grains of materials with each other, and to optimise the electrical conduction in the electrode up to the current collector. Generally speaking, the porosity of the electrodes is optimal between 25 and 40%, and typically around 40% for a correct operation of power electrodes.

It is noted that in the case of a bipolar battery, a power operation is generally preferred.

The choice of a higher porosity, for example 45%, may be motivated by the reduction of the risk of deterioration of the bipolar structure during the calendaring thereof, as well as by the non-alteration of the electrochemical performances.

Normally, the detection of micro-leaks is only performed after stacking of the cell elements, and its operation. It is carried out by detection of abnormal ionic currents. This implies that it has been entirely assembled and activated, and that its non-defective components can no longer be recovered.

### DESCRIPTION OF THE INVENTION

The aim of the invention is thus to overcome at least partially the aforementioned drawbacks, relative to embodiments of the prior art.

To do so, the invention relates to a method for evaluating the sealing of a bipolar structure including a sheet-like substrate forming a current collector, as well as two electrodes in the form of films arranged on the opposite surfaces of the substrate, respectively, the method including the following steps:
placing the bipolar structure in a cavity so as to define first and second compartments therein, which are separated by said bipolar structure, the periphery of which is sealingly connected to the cavity;
circulating a fluid in the first compartment of the cavity toward the second compartment; and
evaluating the sealing of the bipolar structure from a measurement of the difference in the pressure of the fluid in the first and second compartments.

The invention is thus advantageous in that it proves to be extremely reliable and simple for detecting potential leaks through the bipolar structure to be tested. This solution consequently makes it possible to test the components before introducing them into a bipolar stack, preferably an electrochemical generator, then removing defective bipolar structures.

In other words, the principle of the invention is based on the measurement of the intrinsic permeability of the bipolar structure in order to judge its level of integrity in terms of sealing. This test, depending on the value of the measured difference in the pressure providing information on its permeability, thus makes it possible to determine whether the bipolar structure may or not be integrated in a stack to constitute a sealed bipolar electrode, before assembly, activation and operating/cycling.

As an indication, it is noted that the permeability of a porous or fissured medium characterises its aptitude to allow a fluid to flow within its space. It depends on the internal structure of the porous or fissured space, and particularly the shape, the connectivity of its different elements, etc. It is a macroscopic transport property expressing the ratio between a force (pressure gradient) imposed on a fluid to pass through the medium and the resulting flux (flow rate).

Preferably, a support grid is provided in the second compartment, with the bipolar structure pressed against said grid. This avoids deformations of the bipolar structure during the sealing test.

Preferably, said bipolar structure has a total thickness comprised between 10 and 1000 μm, even more preferentially between 20 and 500 μm, and more particularly of the order of 125±50 μm.

Preferably, the fluid is introduced into the first compartment with a flow rate of the order of 60 to 700 litres/hour.

Preferably, the fluid is introduced into the first compartment with a velocity of the order of 2.10⁻⁵ to 2.10⁻¹ m/s.

Preferably, said fluid is a gas, preferably air.

Preferably, said bipolar structure is intended to be integrated in a bipolar electrochemical generator or a super-capacitor with at least one electrode of the bipolar structure operating by insertion of lithium ions or by capacitive phenomenon.

As mentioned above, the structure according to the invention is intended to constitute a “bipolar electrode” with a sheet-like substrate forming a current collector, as well as two electrodes in the form of films arranged on the opposite surfaces of the substrate, respectively. Preferably, the electrodes arranged on either side of the current collector comprise at least one binder of polymeric type, an electrode material, and advantageously an electronic conductor such as carbon.

Polymeric binder is preferably taken to mean binder selected from PVdF, carboxymethyl cellulose, polyacrylic acid, etc.

Among positive electrode active materials, LiCoO₂, LiNi_{0.8}Co_{0.15}Al_{0.05}O₂, Li_{1.04}Mn_{1.96}O₄ LiMn₂O₄, LiNi_{0.33}Mn_{0.33}Co_{0.33}O₂, LiFePO₄, a sulphur based compound, or a mixture thereof, may be cited.

Among negative electrode active materials, TiO₂, Li₄Ti₅O₁₂, silicon, tin, a silicon and tin oxide, a carbon graphite type carbon based compound or a mixture thereof, may be cited.

The current collector according to the invention is constituted of a material selected from one or more metal(s), an electronic conductor polymer or an electronic conductor composite material. Among metals, aluminium, copper, nickel, or a copper and aluminium mixture may be cited.

Preferably the sheet forming the current collector is made of aluminium.

According to a development of the invention, the bipolar electrode is calendered and the sealing test is performed after calendering, and before the bipolar structure is placed in a bipolar battery.

The invention also relates to a bipolar structure comprising a sheet-like substrate forming a current collector, as well as two electrodes in the form of films arranged on the opposite surfaces of the substrate, respectively, said structure having a leakage rate strictly less than 5.10⁻⁵ Pa·m³/s, and preferably strictly less than 1.10⁻⁷ Pa·m³/s. The leakage rates mentioned above are preferentially those observed after calendering of the bipolar structure.

Other advantages and characteristics of the invention will become clear in the detailed non-limiting description given below.

### BRIEF DESCRIPTION OF THE DRAWINGS

This description will be made with reference to the appended drawings, among which;

FIG. 1, already described, represents a schematic view in section of a lithium bipolar electrochemical generator, integrating a bipolar structure intended to undergo a sealing test according to the invention;

FIG. 2 represents a schematic view in section of the bipolar structure integrated in the generator of FIG. 1;

FIG. 3 represents a schematic view in section of an installation enabling the implementation of a method according to a preferred embodiment of the present invention.

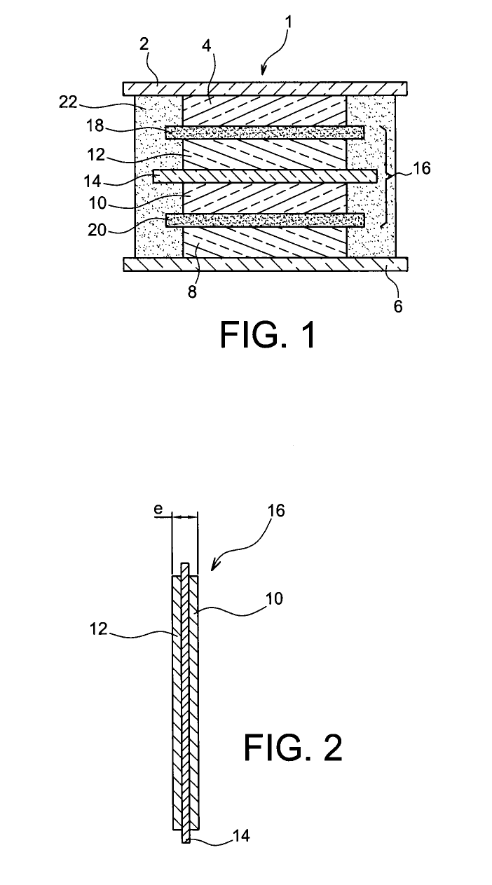

### DETAILED DESCRIPTION OF PREFERRED EMBODIMENTS

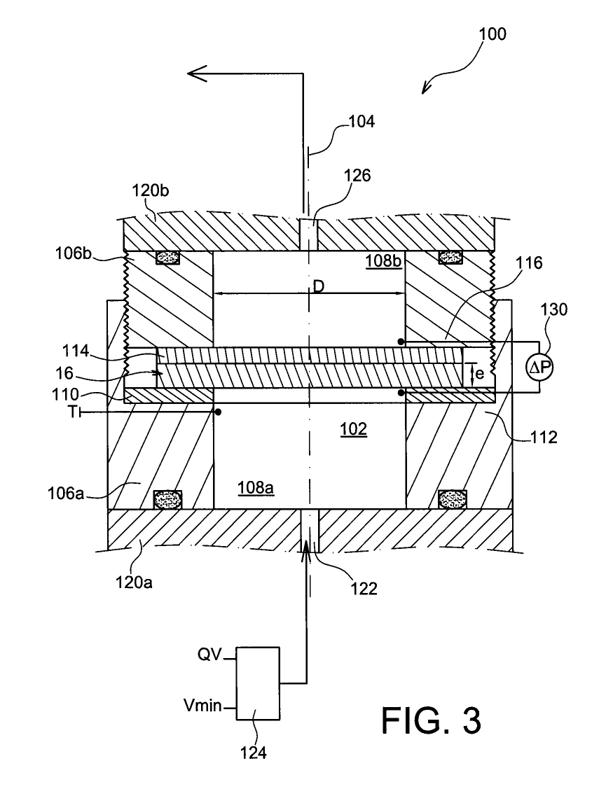

With reference to FIG. 3, an installation 100 is represented enabling the implementation of a method according to a preferred embodiment of the present invention, intended to test the sealing of the bipolar structure 16 shown in FIG. 2, and also referred to as “bipolar electrode”.

This structure 16 has a thickness “e” comprised between 10 and 1000 μm, with a thickness of the aluminium substrate 14 preferably comprised between 10 and 70 μm.

The installation comprises a cavity 102, preferably of cylindrical shape of circular section, centred on the axis 104. The diameter D may be of the order of 16 mm. The cavity 102 is defined by two concentric end pieces 106a, 106b mounted on each other, preferably by screwing. The bipolar structure 16 to be tested is held tight between the two end pieces, and defines on either side thereof a first compartment 108a and a second compartment 108b of the cavity. To do so, the periphery of the structure 16 is sealingly connected to the cavity 102, on the internal wall thereof. As may be seen in FIG. 3, the sealing is achieved by means of a gasket 110 crushed between one end 112 of the shoulder forming end piece 106a, and the periphery of the structure 16. On the other side thereof, in the second compartment, a support grid 114 is held tightly between one end 116 of the shoulder forming end piece 106b, and the periphery of the bipolar structure 16. Said grid is intended to limit the deformation of the structure 16 during the sealing test, which will be described hereafter.

The first compartment 108a is closed opposite the bipolar structure 16 by a first closing piece 120a, sealingly pressed against the first end piece 106a. The closing piece 120a is pierced with a fluid inlet 122 connected to a supply 124, delivering preferably air.

In an analogous manner, the second compartment 108b is closed opposite the bipolar structure 16 by a second closing piece 120b, sealingly pressed against the second end piece 106b. The closing piece 120b is pierced with a fluid outlet 126, preferably open to atmospheric pressure.

Once the installation 100 shown in FIG. 3 is obtained, the method for evaluating the sealing is continued by the circulation of air in the first compartment 108a, by means of the supply 124. This has the consequence of pressing the structure 16 against the grid 114 arranged downstream.

This air supply is carried out preferably at a flow rate Qv of the order of 60 to 700 litres/hour, and at an input velocity Vmin, in the first compartment, of the order of 2.10⁻⁵ to 2.10⁻¹ m/s.

Then, the sealing/the permeability of the bipolar structure 16 is evaluated from a measurement of the difference in air pressure in the first and second compartments, using appropriate sensors 130.

As an indicative example, the bipolar structure 16 may be considered non-compliant when the measured difference in the pressure passes below a predetermined value, bearing witness to a non-acceptable quantity of gas joining the second compartment 108b following one/several fissure(s) within the thickness of the structure 16. Such fissures in fact generate a risk of ionic short-circuit through the current collector 14.

The predetermined value may be fixed by abacuses, depending preferably on a plurality of criteria such as the thickness of the structure 16, the porosity of its electrode forming layers, the temperature T measured by a sensor in the cavity, etc.

In the event of non-compliance, the bipolar structure is then advantageously removed before it is placed in the stack intended to form the electrochemical generator.

As an example, to be compliant, the bipolar structure 16, after calendering, must have a leakage rate strictly less than 5.10⁻⁵ Pa·m³/s, and preferably strictly less than 1.10⁻⁷ Pa·m³/s. Such bipolar electrodes are also the subject matter of the present invention.

Obviously, various modifications may be made by those skilled in the art to the invention that has been described, uniquely by way of non-limiting examples.

1-8. (canceled)

9: A method for evaluating sealing of a bipolar structure including a sheet-like substrate forming a current collector, and two electrodes in a form of films arranged on opposite surfaces of the substrate, respectively, the method comprising:
placing the bipolar structure in a cavity to define first and second compartments therein, which are separated by the bipolar structure, a periphery of which is sealingly connected to the cavity;
circulating a fluid in the first compartment of the cavity toward the second compartment;
evaluating sealing of the bipolar structure from a measurement of difference in pressure of the fluid in the first and second compartments.

10: A method according to claim 9, wherein a support grid is provided in the second compartment, with the bipolar structure pressed against the grid.

11: A method according to claim 9, wherein the bipolar structure has a total thickness between 10 and 1000 μm.

12: A method according to claim 9, wherein the fluid is introduced into the first compartment with a flow rate of an order of 60 to 700 liters/hour.

13: A method according to claim 9, wherein the fluid is introduced into the first compartment with a velocity of an order of 2·10⁻⁵ to 2·10⁻¹ m/s.

14: A method according to claim 9, wherein the fluid is a gas.

15: A method according to claim 9, wherein the bipolar structure is configured to be integrated in a bipolar electrochemical generator or a super-capacitor with at least one electrode of the bipolar structure operating by insertion of lithium ions or by capacitive phenomenon.
